(19) United States
(12) Patent Application Publication
(10) Pub. No.: US 2023/0166346 A1
(43) Pub. Date: Jun. 1, 2023

(54) WELDING TORCH NECK ADAPTERS AND WELDING TORCHES INCLUDING NECK ADAPTERS

(71) Applicant: Illinois Tool Works Inc., Glenview, IL (US)

(72) Inventors: Stephen Bennett, II, Chicago Heights, IL (US); Robert J. Centner, Frankfort, IL (US)

(21) Appl. No.: 18/070,194

(22) Filed: Nov. 28, 2022

Related U.S. Application Data
(60) Provisional application No. 63/283,760, filed on Nov. 29, 2021.

(51) Int. Cl. B23K 9/12; B23K 9/29; B23K 9/173

(52) U.S. Cl. CPC B23K 9/123; B23K 9/295; B23K 9/173

(57) ABSTRACT

An example welding torch neck adapter includes: an electrically conductive body configured to detachably attach to a handle assembly of a consumable electrode-fed welding torch on a first portion of the conductive body and configured to detachably attach to a neck of the welding torch on a second portion of the conductive body to secure the neck to the handle assembly; and a guide tube positioned within the conductive body and configured to support a first consumable wire liner in alignment with a liner lock of a second consumable wire liner.

### TECHNICAL FIELD

This disclosure relates generally to welding torches and, more particularly, to welding torch neck adapters and welding torches including neck adapters.

### BACKGROUND

Wire-fed welding torches often use wire liners to guide the welding wire from a wire feeder to the welding torch. Wire liners reduce wear on the welding torch cable and/or reduce buckling of the wire within the welding torch cable. However, the wire liners themselves are subject to wear, and may occasionally require replacement.

Limitations and disadvantages of conventional and traditional approaches will become apparent to one of skill in the art, through comparison of such systems with the present disclosure as set forth in the remainder of the present application with reference to the drawings.

### BRIEF SUMMARY

Welding torch neck adapters and welding torches including neck adapters are disclosed, substantially as illustrated by and/or described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples, as illustrated in the accompanying figures.

FIG. 1 illustrates an example of a gas metal arc welding (GMAW) system with a power source and a wire feeder, in accordance with aspects of this disclosure.

FIG. 2 is a side view of an example welding torch of the GMAW welding system of FIG. 1.

FIG. 3 is a cross-sectional view of an example welding torch of FIG. 2 including a welding torch neck adapter, and first and second welding wire liners installed.

FIG. 4 is an exploded view of the example welding torch neck adapter of FIG. 3.

FIG. 5 is a perspective view of the example welding torch neck adapter of FIGS. 3 and 4 as assembled.

FIG. 6 is an elevation view of the example welding torch neck adapter of FIGS. 3-5.

FIG. 7A is an cross-sectional elevation view of the example welding torch neck adapter of FIGS. 3-6.

FIG. 7B is an cross-sectional elevation view of the example welding torch neck adapter of FIGS. 3-6, further including the first wire liner lock and the second wire liner in the installed configuration.

FIG. 8 is an end view of the example welding torch neck adapter of FIGS. 3-7B illustrating the gas channels through the welding torch neck adapter.

FIG. 9 is a flowchart representative of an example method that may be performed to assemble a welding torch including the example welding torch neck adapter of FIGS. 3-8.

Where appropriate, the same or similar reference numbers are used to refer to the same or similar elements. The figures are not necessarily to scale.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “rear,” “upper,” “lower,” and the like, are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. The terms “e.g.,” and “for example” set off lists of one or more non-limiting examples, instances, or illustrations. No language in the specification should be construed as indicating any unclaimed element as essential to the practice of the embodiments.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The term “welding-type system,” as used herein, includes any device capable of supplying power suitable for welding, plasma cutting, induction heating, CAC-A and/or hot wire welding/preheating (including laser welding and laser cladding), including inverters, converters, choppers, resonant power supplies, quasi-resonant power supplies, etc., as well as control circuitry and other ancillary circuitry associated therewith.

The term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

The terms “circuit” and “circuitry” includes any analog and/or digital components, power and/or control elements, such as a microprocessor, digital signal processor (DSP), software, and the like, discrete and/or integrated components, or portions and/or combinations thereof.

The terms “control circuit” and “control circuitry,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards, which form part or all of a controller, and are used to control a welding process, a device such as a power source or wire feeder, motion, automation, monitoring, air filtration, displays, and/or any other type of welding-related system.

The term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

The term “torch,” “welding torch,” “welding tool,” or “welding-type tool” refers to a device configured to be manipulated to perform a welding-related task, and can include a hand-held welding torch, robotic welding torch, gun, or other device used to create the welding arc.

In wire-fed welding processes, wire liners are used to line the path between a source of welding wire (e.g., filler wire) and the welding torch (e.g., a GMAW torch, an FCAW torch, a SAW torch, etc.). The welding wire liner is secured in place at the end of the welding torch cable at which the welding torch is connected and disconnected from the wire feeder (e.g., at a power connection assembly), because movement of the wire liner relative to the power connection assembly (referred to herein as “wire liner movement”) can adversely affect welds made using the torch. Potential effects of wire liner movement include gas leakage at the power pin (e.g., leading to weld porosity), wire feeding issues, and/or liners dragging on feeder drive rolls.

Some types of wire liners are loaded from the rear, or cable end, of the welding torch assembly. Other types of wire liners are loaded from the front, or welding torch, end of the welding torch assembly. Conventional front-loading wire liners have a single-piece gun liner, which is installed from the front of the gun thru the neck, into the gun cable, and finally out thru the rear of the welding torch cable. Conventional front-loading wire liners are retained in place by a gas diffuser on one end at the torch, and by a power pin cap on the cable end of the torch assembly. In some cases, the gas diffuser and/or other elements of the welding torch assembly have features that cooperate with the front-loading wire liner.

Conventional front-loading wire liners do not allow the torch neck to be removed from the handle assembly of the torch without fully removing the single-piece wire liner. As a result, changing welding torch necks to adapt to different welding conditions or arrangements is time-consuming due to the time involved in installing and trimming the wire liner to the correct size each time a welding torch neck is changed. Examples of front-loading wire liners are disclosed in Centner (U.S. Patent Publication No. 2017/0165780) and Centner (U.S. Patent Publication No. 2017/0282278). The entireties of U.S. Patent Publication No. 2017/0165780 and U.S. Patent Publication No. 2017/0282278 are incorporated herein by reference.

Disclosed methods and apparatus involve using a two-piece wire liner and a welding torch neck adapter that would allow a liner segment to remain in place within the gun cable when the neck is removed. A second, separate liner segment is contained within the neck of the welding torch. Accordingly, disclosed methods and apparatus enable faster and more convenient removal and replacement of a torch neck without having to remove a wire liner from the torch cable when using front-loading wire liners and/or cooperating welding torch assemblies.

In some examples, the welding torch assembly is provided with an adapter, which secures a first, rearward wire liner in place, attaches the neck to the torch handle assembly (e.g., at the location at which the neck would have been directly attached to the torch handle assembly), and aligns the first wire liner with the second, separate wire liner in the neck. The adapter provides a junction point for the two liner segments. In some examples, the adapter enables use of conventional torch components that support the single front-loading wire liner, thereby enabling conversion and/or retrofitting of conventional front-loading wire liner torches and systems to use two-piece wire liners.

Disclosed example welding torch neck adapters accept a welding torch neck on one end, and seat into a neck receiver on the gun cable or handle assembly on the opposing end of the adapter. Example adapters contain a recess or pocket to fit over a liner lock (e.g., a crimped brass fitting or other liner end fitting) on the end of a wire liner.

To install or assemble the torch assembly with the neck adapter, a first wire liner having a first wire liner lock is inserted into the torch cable via the handle assembly while the neck and adapter removed from the gun cable. The first liner is fed into the torch cable until the first wire liner lock reaches the torch cable. A first end of the neck adapter is then installed into the neck receiver of the torch cable at the handle assembly, over the first liner lock, which secures the liner lock end of the first wire liner from movement, at which time the first liner may be trimmed and locked via the locking cap. A shorter, second liner segment with a second liner lock (which may be similar or identical to the first liner lock) is installed into the front of the neck, secured (e.g., with a conventional gas diffuser, nozzle, or other component), and trimmed (e.g., even with the end of the neck which is to interface with the adapter). The neck is then installed into the exposed end of the neck adapter attached to the gun cable or handle assembly. The neck adapter includes a guide tube that serves to align the free end of the second liner in the neck with the centerline of the neck adapter as the neck is attached, and centers the first liner lock.

In some examples, the neck adapter is configured with gas ports (e.g., holes, orifices) to allow gas to flow smoothly from the gun cable, through the adapter, and into the gun neck. The guide tube is also configured such that sufficient gas flow is permitted to flow from the neck adapter into the neck. In some examples, the neck adapter is conductive to conduct welding-type current from the welding cable to the neck for delivery to the gas diffuser and contact tip. To this end, the example neck adapter includes an exterior taper to make electrical contact and/or provide a gas seal against one of the welding cable or the neck, and/or an interior taper to make electrical contact and/or provide a gas seal against the other of the welding cable or the neck.

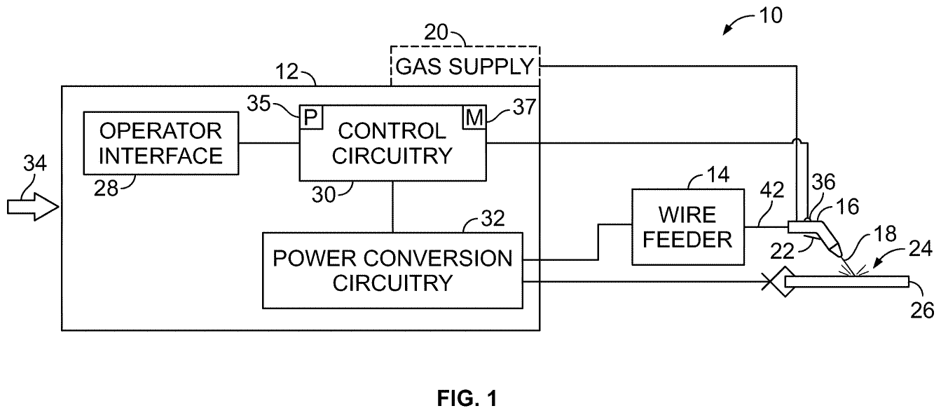

FIG. 1 illustrates an example of a gas metal arc welding (GMAW) system 10 with a power source 12 and a wire feeder 14. In the illustrated example, the power source 12 is separate from the wire feeder 14, such that the wire feeder 14 may be positioned at some distance from the power source 12 near a welding location. However, it should be understood that the wire feeder 14, in some implementations, may be integral with the power source 12. The power source 12 may supply weld power to a torch 16 through the wire feeder 14, or the power source 12 may supply weld power directly to the torch 16. The wire feeder 14 supplies a wire electrode 18 (e.g., solid wire, cored wire, coated wire) to the torch 16. A gas supply 20, which may be integral with or separate from the power source 12, supplies a gas (e.g., CO2, argon) to the torch 16. An operator may engage a trigger 22 of the torch 16 to initiate an arc 24 between the electrode 18 and a work piece 26. In some examples, the welding system 10 may be triggered by an automation interface including, but not limited to, a programmable logic controller (PLC) or robot controller. The welding system 10 is designed to provide welding wire (e.g., electrode 18), weld power, and shielding gas to the welding torch 16. As will be appreciated by those skilled in the art, the welding torch 16 may be of many different types, and may facilitate use of various combinations of electrodes 18 and gases.

The welding system 10 may receive data settings from the operator via an operator interface 28 provided on the power source 12. The operator interface 28 may be incorporated into a faceplate of the power source 12, and may allow for selection of settings such as the weld process (e.g., stick, TIG, MIG), the type of electrode 18 to be used, voltage and current settings, transfer mode (e.g., short circuit, pulse, spray, pulse), and so forth. In particular, the welding system 10 allows for MIG welding (e.g., pulsed MIG welding) with electrodes 18 (e.g., welding wires) of various materials, such as steel or aluminum, to be channeled through the torch 16. The weld settings are communicated to control circuitry 30 within the power source 12.

The control circuitry 30 operates to control generation of welding power output that is applied to the electrode 18 by power conversion circuitry 32 for carrying out the desired welding operation. For example, the control circuitry 30 may be adapted to regulate a pulsed MIG welding regime that may have aspects of short circuit transfer and/or of spray transfer of molten metal from the welding wire to a molten weld pool of a progressing weld. Such transfer modes may be controlled during operation by adjusting operating parameters of current and voltage pulses for arcs 24 developed between the electrode 18 and the work piece 26.

The control circuitry 30 is coupled to the power conversion circuitry 32, which supplies the weld power (e.g., pulsed waveform) that is applied to the electrode 18 at the torch 16. The power conversion circuitry 32 is coupled to a source of electrical power as indicated by arrow 34. The power applied to the power conversion circuitry 32 may originate in the power grid, although other sources of power may also be used, such as power generated by an engine-driven generator, batteries, fuel cells or other alternative sources. Components of the power conversion circuitry 32 may include choppers, boost converters, buck converters, inverters, and so forth.

The control circuitry 30 controls the current and/or the voltage of the weld power supplied to the torch 16. The control circuitry 30 may monitor the current and/or voltage of the arc 24 based at least in part on one or more sensors 36 within the wire feeder 14 or torch 16. In some embodiments, a processor 35 of the control circuitry 30 determines and/or controls the arc length or electrode extension based at least in part on feedback from the sensors 36. The arc length is defined herein as the length of the arc between the electrode 18 and the work piece 26. The processor 35 determines and/or controls the arc length or electrode extension utilizing data (e.g., algorithms, instructions, operating points) stored in a memory 37. The data stored in the memory 37 may be received via the operator interface 28, a network connection, or preloaded prior to assembly of the control circuitry 30. Operation of the power source 12 may be controlled in one or more modes, such as a constant voltage (CV) regulation mode in which the control circuitry 30 controls the weld voltage to be substantially constant while varying the weld current during a welding operation. That is, the weld current may be based at least in part on the weld voltage. Additionally or alternatively, the power source 12 may be controlled in a current control mode in which the weld current is controlled independent of the weld voltage. In some examples, the power source 12 is controlled to operate in a constant current (CC) mode where the control circuitry 30 controls the weld current to be substantially constant while varying the weld voltage during a welding operation.

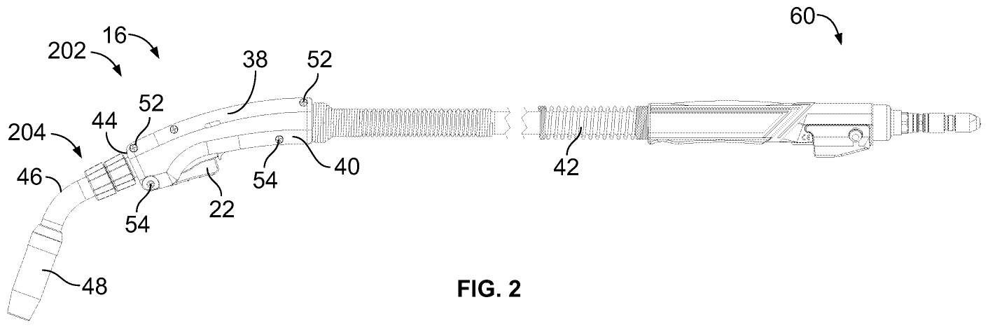

FIG. 2 is a side view of an example welding torch 16 of the GMAW welding system 10 of FIG. 1. The example torch 16 includes the trigger 22 for initiating a weld and supplying the electrode 18 to the weld. Specifically, the trigger 22 is disposed on a handle 38. A welding operator holds the handle 38 when performing a weld. At a first end 40, the handle 38 is coupled to a cable 42 where welding consumables (e.g., the electrode, the shielding gas, and so forth) are supplied to the weld. Welding consumables generally travel through the handle 38 and exit at a second end 44, which is disposed on the handle 38 at an end opposite from the first end 40.

The torch 16 includes a neck 46 extending out of the second end 44 of the handle 38. As such, the neck 46 is coupled between the handle 38 and a welding nozzle 48. As should be noted, when the trigger 22 is pressed or actuated, welding wire (e.g., electrode 18) travels through the cable 42, the handle 38, the neck 46, and the welding nozzle 48, so that the welding wire extends out of an end 50 (i.e., torch tip) of the welding nozzle 48. Further, as illustrated in FIG. 2, the handle 38 is secured to the neck 46 via fasteners 52 and 54, and to the cable 42 via fasteners 52 and 54. The welding nozzle 48 is illustrated with a portion of the welding nozzle 48 removed to show the electrode 18 extending out of a contact tip 56 that is disposed within the welding nozzle 48.

To connect the torch 16 to the wire feeder 14, a rear connector assembly 60 is disposed at a rear axial end of the weld cable 42. The rear connector assembly 60 serves to align the welding torch liner with a centerline of a corresponding connector of the wire feeder 14. The rear connector assembly 60 serves as an entry point of the welding wire into the welding torch 16. The rear connector assembly 60 includes a wire liner retention assembly to limit movement of a welding wire liner relative to the rear connector assembly 60, both axially and longitudinally.

The example torch 16 may be implemented using one or more of the features, components, and/or apparatus described in U.S. Patent Application Publication No. 2017/0165780, filed Dec. 6, 2016, and/or in U.S. Patent Application Publication No. 2017/0282278, filed Jun. 14, 2017.

As described in more detail below, the example torch 16 may be configured or retrofitted with a neck adapter to allow use of a two-piece welding wire liner, which enables removal of the neck 46 from the handle 38 and/or the cable 42 without removal of the wire liner from the cable 42.

In some examples, the handle 38 and the cable 42 form a handle assembly 202. In some handle assemblies, the cable 42 extends through the length of the handle to make direct electrical and mechanical contact with the neck and/or neck adapter. In other handle assemblies, the cable 42 is electrically and mechanically coupled to a rear end or intermediate portion of the handle 38, which provides an electrical and mechanical connection between the cable 42 and the neck or neck adapter.

In some examples, the neck 46 and a gas diffuser (not shown in FIG. 2) form a neck assembly 204. The neck assembly supports and retains a wire liner, as part of a single-piece or two-piece wire liner system, for delivery of consumable electrode wire. The neck assembly may further include a contact tip, nozzle, insulator, and/or any other components for delivery of electrical current, shielding gas, and consumable electrode wire to a welding arc from the handle assembly.

The wire liner(s) of disclosed examples may be referred to herein as wire liner assemblies, which include a wire liner and a liner lock. The wire liner may be constructed as, for example, a tightly coiled wire or plastic tube, having an annulus through which a consumable electrode wire is fed. The liner lock may include, for example, a piece of brass or other rigid structure crimped onto an end of the wire liner. Example liner locks include a flange or shoulder, and a bullnose portion. However, other liner lock structures may be used.

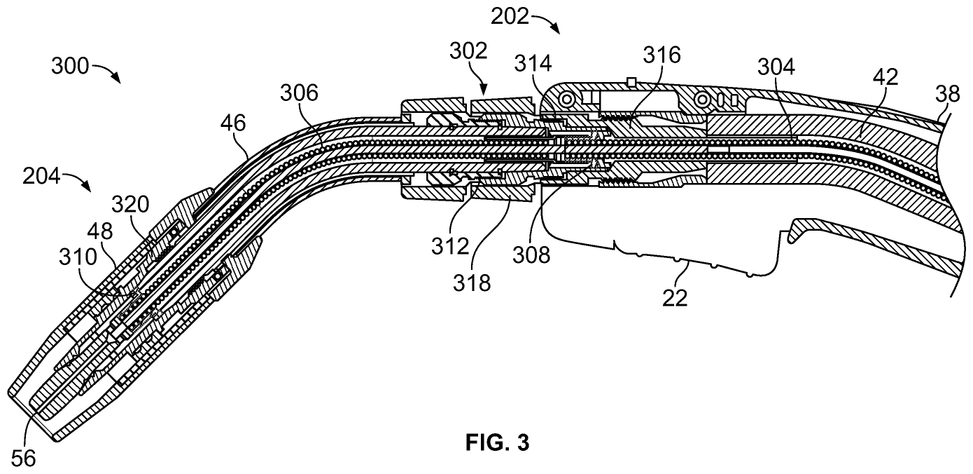

FIG. 3 is a cross-sectional view of an example welding torch 300 configured to further include a welding torch neck adapter 302, and wire liner assemblies 304, 306 installed in the welding torch 16. The example welding torch 300 may be similar or identical to the welding torch 16 of FIG. 2, further fitted with the neck adapter 302 and the welding wire liner assemblies 304, 306.

As illustrated in FIG. 3, the neck adapter 302 is coupled to the handle assembly 202 (e.g., to the weld cable 42 within the handle 38) on a first end, and connected to the neck assembly 204 (e.g., to the neck 46) on a second end. The wire liner assembly 304 (e.g., a cable liner assembly) includes a cable liner lock 308, and the wire liner assembly 306 (e.g., a neck liner assembly) includes a neck liner lock 310. As described in more detail below, the liner locks 308, 310 limit the axial movement of the respective wire liner assemblies 304, 306.

In the absence of the neck adapter 302, an exterior thread 312 of the neck 46 is mechanically and electrically coupled to an interior thread 314 of the weld cable 42 within the handle 38, and a single wire liner extends from the front end of the neck 46 to the rear end of the weld cable 42. The cable 42 includes a fitting 316, which has the interior thread 314 to which the neck 46 and/or the neck adapter 302 are detachably attached.

When installed in combination with the cable wire liner assembly 304 and the neck wire liner assembly 306, the example welding torch neck adapter 302 of FIG. 3 detachably couples the handle assembly 202 (e.g., the handle 38 or weld cable 42) to the neck assembly 204 (e.g., to the neck 46), and aligns a first (e.g., rearward, away from the contact tip 56) end of the neck wire liner assembly 306 with the cable liner lock 308 of the cable wire liner assembly 304.

The example neck assembly 204 includes a gas diffuser 320, which retains the liner lock 310 of the neck wire liner assembly 306 to limit axial movement of the liner lock 310 and the neck wire liner assembly 306. The gas diffuser 320 conducts electrical current from the neck 46 to the contact tip 56, and permits gas flow from the neck 46 into the interior of the nozzle 48. The handle assembly 202, neck 46, diffuser 320, contact tip 56, and/or nozzle 48 may be implemented as described in 2017/0165780 and/or in U.S. Patent Application Publication No. 2017/0282278.

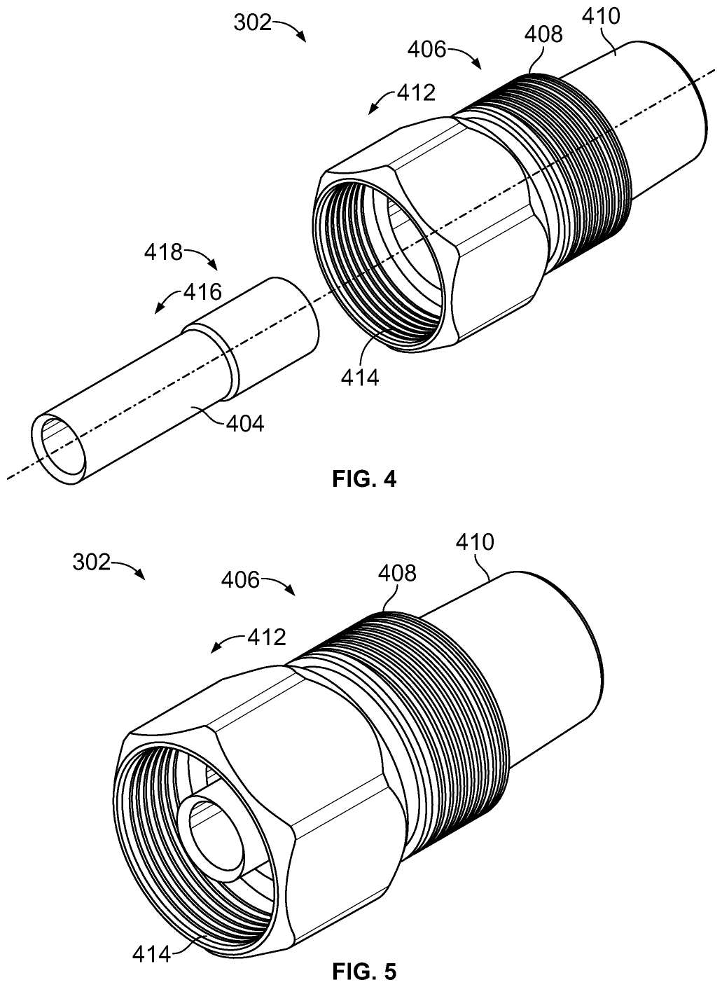

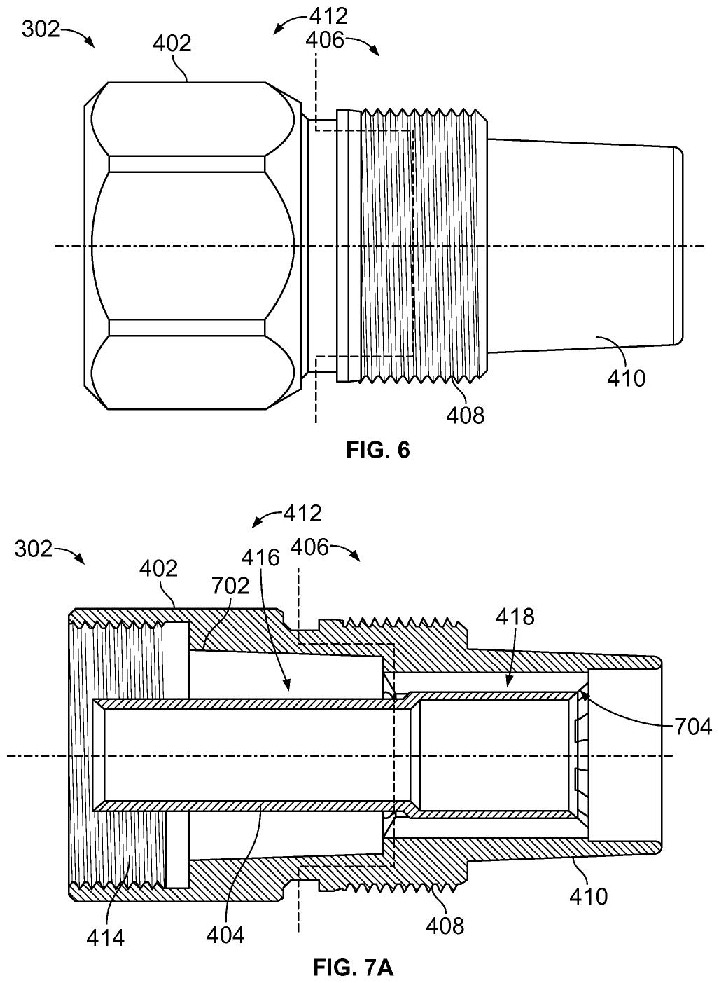

FIG. 4 is an exploded view of the example welding torch neck adapter 302 of FIG. 3. As shown in FIG. 4, the neck adapter 302 includes an electrically conductive body 402 and a guide tube 404 positioned within the conductive body. FIG. 5 is a perspective view of the example welding torch neck adapter 302 of FIGS. 3 and 4 as assembled. FIG. 6 is an elevation view of the example welding torch neck adapter 302 of FIGS. 3-5. FIG. 7A is an cross-sectional elevation view of the example welding torch neck adapter 302 of FIGS. 3-5. FIG. 7B is an cross-sectional elevation view of the example welding torch neck adapter 302 of FIGS. 3-6, further including the first liner lock 308 and the second wire liner assembly 306 in the installed configuration.

The body 402 detachably attaches to the handle assembly 202 (e.g., to the cable 42 and/or the handle 38) on a first portion 406 of the conductive body 402. The first portion 406 of the conductive body 402 includes exterior threads 408, which electrically and mechanically couple the conductive body 402 to the handle assembly 202 (e.g., via the interior threads 314 of the fitting 316). However, in other examples, the exterior threads 408 may be replaced with any other type of electrical and mechanical connection, such as a quick connector or any other type of connection used by the handle assembly 202 to connect the neck assembly 204. In the example of FIGS. 4-6, the first portion 406 further includes an exterior taper 410 adjacent the exterior threads 408 on the exterior of the conductive body 402. The exterior taper 410 improves the electrical contact with the conductor (e.g., the fitting 316) in the handle assembly 202 when attached to the handle assembly 202. Additionally or alternatively, the body 402 may include other features to make or improve the electrical connection between the body 402 and the cable 42, such as high current spring contacts or other features.

The example body 402 is also configured to detachably attach to the neck assembly 204 (e.g., the neck 46) of the welding torch 300 on a second portion 412 of the body 402, to thereby secure the neck assembly 204 to the handle assembly 202. To this end, the second portion 412 of the body 402 includes interior threads 414, which electrically and mechanically couple the body 402 to the neck assembly 204 (e.g., via the exterior threads 312 of the neck 46). However, in other examples, the interior threads 414 may be replaced with any other type of electrical and mechanical connection, such as a quick connector or any other type of connection used by the handle assembly 202 to connect the neck assembly 204. As shown in the example of FIG. 7A below, the second portion 412 further includes an interior taper 702 adjacent the interior threads 414 on the interior of the body 402. The interior taper 702 improves the electrical contact with the neck 46 when attached to the neck 46. Additionally or alternatively, the body 402 and/or the neck 46 may include other features to make or improve the electrical connection between the body 402 and the neck 46, such as high current spring contacts or other features.

In the example of FIGS. 6 and 7A-7B, the first portion 406 of the body 402 refers to and includes those features which connect or interface the neck adapter 302 with the handle assembly 202. Conversely, the second portion 412 of the body 402 refers to and includes those features which connect or interface the neck adapter 302 with the neck assembly 204.

The guide tube 404 is configured to support the neck wire liner assembly 306 in alignment with the liner lock 308 of the cable wire liner assembly 304. In the examples of FIGS. 3-7B, the liner portions of the liner assemblies 304, 306 have the same diameter. In such examples, the guide tube 404 has a first portion 416 having a first inner diameter and a first outer diameter, and a second portion 418 having a second inner diameter larger than the first inner diameter. The first inner diameter of the first portion 416 is selected to support the neck wire liner assembly 306 and to limit radial movement of the neck wire liner assembly 306 to improve alignment of the wire liner assemblies 304, 306. The second inner diameter of the second portion 418 is selected to capture at least a portion (e.g., the nose) of the cable liner lock 308, to limit radial movement of the cable liner lock 308 to improve alignment with the neck wire liner assembly 306.

In other examples, in which the cable wire liner assembly 304 is sized differently than the neck wire liner assembly 306 (e.g., a different outer and/or inner diameter), the first and second portions 416, 418 of the guide tube 404 may have identical inner diameters, or different inner diameters that are also different than the inner diameters in the example of FIGS. 3-7B.

As illustrated in FIGS. 7A and 7B, the example body 402 includes a chamfer 704 in an interior of the first portion 404 of the body 402. In the example of FIGS. 7A and 7B, an end of the second portion 418 of the guide tube 404 is aligned with the chamfer 704 when installed. The chamfer 704 aids in capturing and aligning the cable liner lock 308 within the guide tube 404 during installation of the neck adapter 302 into the handle assembly 202. The chamfer 704 also provides a stopping surface for the cable liner lock 308 (e.g., on the shoulder or flange portion of the example cable liner lock 308). The chamfer 704 and the fitting 316 limit axial movement of the cable wire liner assembly 304 by limiting the axial movement of the cable liner lock 308.

The guide tube 404 may be press fit or otherwise secured within the first portion 406 of the body 402, and the first portion 416 of the guide tube 404 extends toward the second portion 412 of the body 402. In other examples, the guide tube 404 may be integral to the body 402, by machining, additive manufacturing, and/or any other construction techniques. The first portion 416 of the guide tube 404 is dimensioned to fit within the neck 46 and to fit the neck wire liner assembly 306 within the guide tube 404.

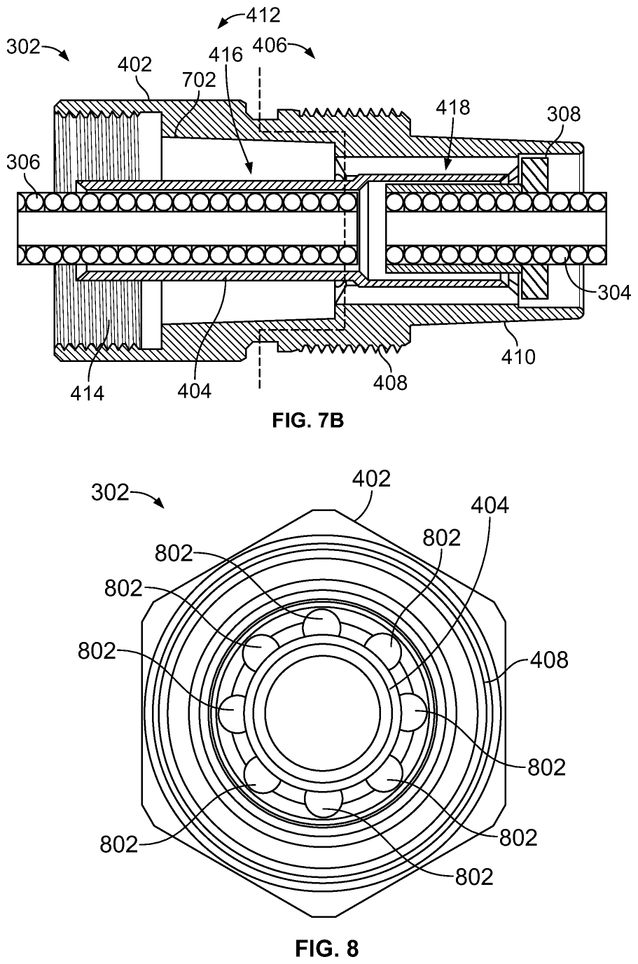

The example body 402 further includes gas channels to permit passage of shielding gas from the handle assembly 202 to the neck assembly 204 of the welding torch 300 via the adapter 302. FIG. 8 is an end view of the example welding torch neck adapter 302 illustrating the gas channels 802 through the welding torch neck adapter 302. The gas channels 802 extend axially adjacent an exterior surface of the guide tube 404. An outer diameter of the first portion 416 of the guide tube 404 is smaller than the outer diameter of the second portion 418 of the guide tube 404, to permit the shielding gas to flow from the channels 802 toward the neck assembly 204 via the second portion of the conductive body 402. The channels 802 may be drilled or otherwise machined out of the interior of the body 402 prior to insertion of the guide tube 404.

The example cable liner lock 308 is provided with similar longitudinal gas channels on the shoulder or flange portion, which allows gas to flow through the cable liner lock 308 to the gas channels 802 in the body 402.

Returning to FIG. 3, the example neck adapter 302 may be further provided with an insulator 318, such as a plastic nut, configured to fit over the body 402. The insulator 318 electrically insulates the conductive body 402 from the environment or operator, and may include knurling, detents, texturing, or other features to allow for tightening of the adapter 302 into the handle assembly 202 to the desired torque and/or untightening of the adapter 302 from the handle assembly 202. The insulator 318 may be installed via overmolding, snapping multiple parts together, securing components with one or more fasteners, and/or otherwise installed on the body 402.

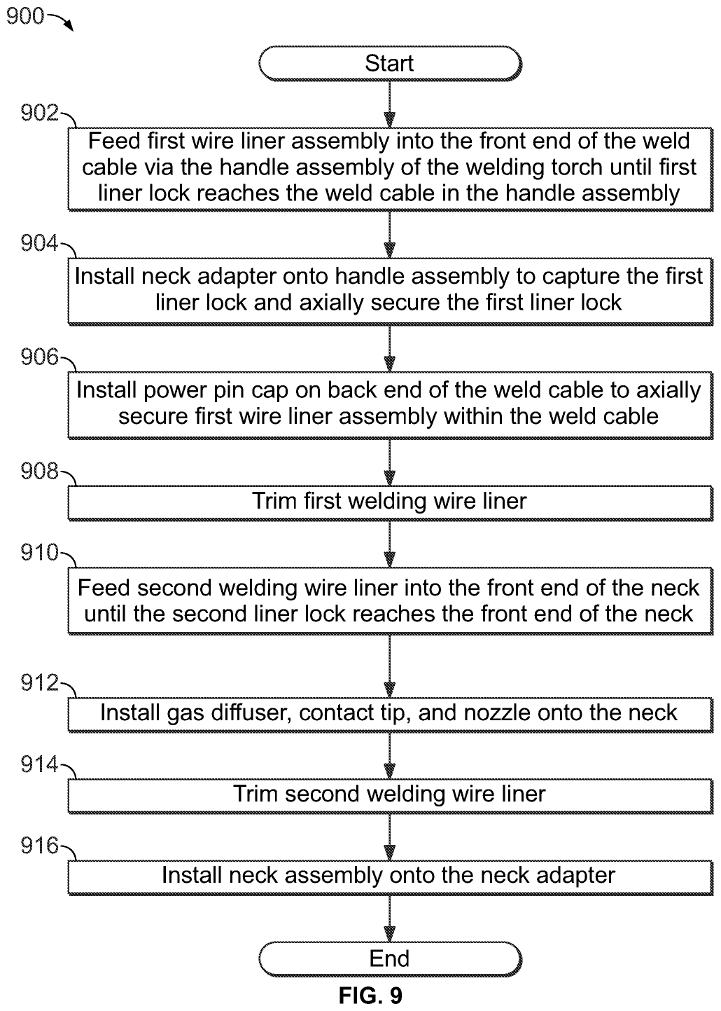

FIG. 9 is a flowchart representative of an example method 900 that may be performed to assemble a welding torch including the example welding torch neck adapter of FIGS. 3-8. The example method 900 may be performed by a weld operator or other individual, and begins when there is no welding wire liner present in the torch, cable, or connector, and the nozzle, contact tip, and gas diffuser are removed from the torch, and the neck assembly 204 of FIG. 2 is detached from the handle assembly 202.

At block 902, the operator feeds a first welding wire liner (e.g., the cable wire liner assembly 304) into the front end of the handle assembly 202 (e.g., into the cable 42 within the handle 38), until cable liner lock 308 reaches the handle assembly 202 (e.g., reaches the cable 42).

At block 904, the operator installs the neck adapter 302 onto the handle assembly 202 to capture the cable liner lock 308 (e.g., within the guide tube 402) and axially secure the cable liner lock 308. For example, the operator connects the exterior threads 408 to the threads of the fitting 316 to secure the exterior taper 410 against the fitting 316.

At block 906, the operator installs a power pin cap on a back end of the weld cable 42 to axially secure the cable wire liner assembly 304 within the weld cable 42 (e.g., at the rear connector assembly 60 of FIG. 2). At block 908, the operator trims the cable wire liner assembly 304 (e.g., flush with the rear connector assembly 60).

At block 910, the operator feeds a second welding wire liner (e.g., the neck wire liner assembly 306) into a front end of the neck 46 until the neck liner lock 310 reaches the front end of the neck 46. At block 912, the operator installs the gas diffuser, contact tip, and nozzle onto the neck 46, which axially secures the neck liner lock 310. In some examples, the operator may install only the gas diffuser, and install the contact tip and/or nozzle at a later time.

At block 914, the operator trims the neck wire liner assembly 306 (e.g., flush with the end of the neck 46). In some examples, the length of the guide tube 404 and the body 402 are configured to set an upper and/or lower distance between the trimmed neck wire liner assembly 306 and the cable liner lock 308 when the neck 46 is installed on the neck adapter 302.

At block 916, the operator then installs the neck assembly 204 (including the neck wire liner assembly 306 onto the neck adapter 302. The example method 900 then ends.

While the present apparatus, systems, and/or methods have been described with reference to certain implementations, it will be understood by those skilled in the art that various changes may be made and equivalents may be substituted without departing from the scope of the present apparatus, systems, and/or methods. In addition, many modifications may be made to adapt a particular situation or material to the teachings of the present disclosure without departing from its scope. Therefore, it is intended that the present apparatus, systems, and/or methods not be limited to the particular implementations disclosed, but that the present apparatus, systems, and/or methods will include all implementations falling within the scope of the appended claims.

What is claimed is:

1. A welding torch neck adapter, comprising:
an electrically conductive body configured to detachably attach to a handle assembly of a consumable electrode-fed welding torch on a first portion of the conductive body and configured to detachably attach to a neck of the welding torch on a second portion of the conductive body to secure the neck to the handle assembly; and
a guide tube positioned within the conductive body and configured to support a first consumable wire liner in alignment with a liner lock of a second consumable wire liner.

2. The welding torch neck adapter as defined in claim 1, wherein the guide tube comprises a first portion having a first inner diameter and a second portion having a second inner diameter larger than the first inner diameter, the first inner diameter configured to support the first consumable wire liner.

3. The welding torch neck adapter as defined in claim 2, wherein the second portion of the guide tube is positioned within the first portion of the conductive body, and the first portion of the guide tube is positioned within the second portion of the conductive body.

4. The welding torch neck adapter as defined in claim 2, wherein a second outer diameter of the second portion of the guide tube is larger than a first outer diameter of the first portion of the guide tube.

5. The welding torch neck adapter as defined in claim 1, wherein the conductive body comprises interior gas channels between the first portion and the second portion, to permit passage of shielding gas from the handle assembly of the welding torch to the neck of the welding torch.

6. The welding torch neck adapter as defined in claim 1, wherein the first portion of the conductive body comprises first exterior threads configured to mate with first interior threads of the handle assembly, and the second portion of the conductive body comprises second interior threads configured to mate with second exterior threads of the neck.

7. The welding torch neck adapter as defined in claim 6, wherein the first exterior threads are adjacent a first taper on an exterior of the conductive body configured to make electrical contact with a conductor in the handle assembly when attached to the handle assembly, and the second interior threads are adjacent a second taper on an interior of the conductive body configured to make electrical contact with a conductor in the neck when attached to the neck.

8. The welding torch neck adapter as defined in claim 1, wherein the first portion of the conductive body comprises a chamfer, an end of the second portion of the guide tube configured to align with the chamfer when positioned within the conductive body.

9. The welding torch neck adapter as defined in claim 8, wherein the chamfer and the second portion of the guide tube are configured to capture the liner lock within the second portion of the guide tube during installation of the welding torch neck adapter.

10. The welding torch neck adapter as defined in claim 1, wherein the first portion of the conductive body has a taper on an exterior of the conductive body to make electrical contact with a conductor in the handle assembly when attached to the handle assembly.

11. The welding torch neck adapter as defined in claim 1, wherein the second portion of the conductive body has a taper on an interior of the conductive body to make electrical contact with a conductor in the neck when attached to the neck.

12. The welding torch neck adapter as defined in claim 1, wherein the first portion of the guide tube extends from the second portion of the conductive body to the first portion of the conductive body.

13. A welding torch, comprising:
a handle assembly coupled to a torch cable for delivery of consumable electrode wire, welding-type current, and shielding gas;
a neck assembly configured to deliver the consumable electrode wire, the welding-type current, and the shielding gas to a welding arc, the neck assembly comprising a neck, a contact tip, and a gas diffuser;
a first wire liner assembly extending through the handle assembly and the torch cable, and comprising a first liner lock configured to limit movement of the first wire liner assembly into the handle assembly;
a second wire liner assembly extending from a position within the neck assembly toward the handle assembly and comprising a second liner lock configured to limit movement of the second wire liner assembly into the neck assembly; and
a neck adapter configured to detachably couple the handle assembly to the neck assembly and align a first end of the second wire liner assembly with the first liner lock of the first wire liner assembly.

14. The welding torch as defined in claim 13, wherein the neck assembly is detachable from the neck adapter without removal of the first wire liner assembly from the handle assembly.

15. The welding torch as defined in claim 13, wherein the neck adapter comprises:
a conductive body configured to detachably attach to the handle assembly on a first portion of the conductive body and configured to detachably attach to the neck on a second portion of the conductive body to secure the neck to the handle assembly; and
a guide tube positioned within the conductive body and configured to support the second wire liner assembly in alignment with first liner lock of the first wire liner assembly.

16. The welding torch as defined in claim 15, wherein the guide tube comprises a first portion having a first inner diameter and a second portion having a second inner diameter larger than the first inner diameter, the first inner diameter configured to support the second wire liner assembly.

17. The welding torch as defined in claim 16, wherein the second portion of the guide tube is positioned within the first portion of the conductive body, and the first portion of the guide tube is positioned within the second portion of the conductive body.

18. The welding torch as defined in claim 16, wherein a second outer diameter of the second portion of the guide tube is larger than a first outer diameter of the first portion of the guide tube.

19. The welding torch as defined in claim 15, wherein the conductive body comprises interior gas channels between the first portion and the second portion, to permit passage of shielding gas from the handle assembly of the welding torch to the neck of the welding torch.

20. The welding torch as defined in claim 15, wherein the first portion of the conductive body comprises first exterior threads configured to mate with first interior threads of the handle assembly, and the second portion of the conductive body comprises second interior threads configured to mate with second exterior threads of the neck.
